(19) United States
(12) Patent Application Publication
(10) Pub. No.: US 2020/0003653 A1
(43) Pub. Date: Jan. 2, 2020

(54) ANALYZING DEVICE, DIAGNOSING DEVICE, ANALYSIS METHOD, AND COMPUTER-READABLE RECORDING MEDIUM

(71) Applicant: NEC Corporation, Minato-ku, Tokyo (JP)

(72) Inventors: Soichiro TAKATA, Tokyo (JP); Takahiro KUMURA, Tokyo (JP); Katsumi KIKUCHI, Tokyo (JP)

(73) Assignee: NEC Corporation, Minato-ku, Tokyo (JP)

(21) Appl. No.: 16/493,373

(22) PCT Filed: Mar. 22, 2018
(86) PCT No.: PCT/JP2018/011380

§ 371 Date: Sep. 12, 2019

(30) Foreign Application Priority Data
Mar. 31, 2017 (JP) 2017-070399

(51) Int. Cl. G01M 5/00

(52) U.S. Cl. CPC G01M 5/0033; G01M 5/0066; G01M 5/0025

(57) ABSTRACT

Provided is an analysis device which enables highly accurate diagnosis of a structure state. An analysis device includes a system identification unit, an input modeling unit, an input generation unit, and a response calculation unit. The system identification unit identifies a model representing time evolution of a structure using a non-Gaussian random process, based on a distribution of response of the structure. The input modeling unit generates a probability model representing a distribution of an input, based on data indicating fluctuation of the input to the structure. The input generation unit generates an input signal for the structure based on the probability model. The response calculation unit random response of vibration occurring in the structure in response to the input signal, based on the model and the input signal.

### TECHNICAL FIELD

The present invention relates to an analyzing device, a diagnosing device, an analysis method, and a computer-readable recording medium.

### BACKGROUND ART

Structures such as water pipes deteriorate due to long-term use. In order to accurately grasp the state of deterioration, techniques for predicting and diagnosing the state of deterioration have been developed.

PTL 1 describes a deterioration degree prediction method and the like of a device. The deterioration degree prediction method of the device described in PTL 1 uses recursion period based on statistical distribution of extrema of measured values of physical property for deterioration degree determination derived at any given plurality of points of the device to estimate the maximum or minimum value of the physical property of the device from the values. Then, the deterioration degree prediction method of the device described in PTL 1 predicts the maximum value of deterioration of the device from a database of relation derived in advance between the deterioration degree of the material and the characteristics.

### CITATION LIST

### Patent Literature

[PTL 1] Japanese Unexamined Patent Application Publication No. H2-167463A

### SUMMARY OF INVENTION

### Technical Problem

A failure of a structure may be categorized as initial failure, catastrophic failure, and wear failure. For structures in service, the catastrophic failure and wear failure should be considered. And, when diagnosing a structure, it is preferable that both failures be evaluated. That is, for the technique described in PTL 1 and the like, a technique that enables various diagnoses of a structure is desired.

The present invention has been made to solve the above-described problems, and its main object is to provide an analysis device or the like which enables highly accurate diagnosis of a structure state.

### Solution to Problem

An analysis device, according to an aspect of the present invention, includes: system identification means for identifying a model representing time evolution of a structure using a non-Gaussian random process, based on a distribution of response of the structure; input modeling means for generating a probability model representing a distribution of an input, based on data indicating fluctuation of the input to the structure; input generation means for generating an input signal for the structure based on the probability model; and response calculation means for deriving random response of vibration occurring in the structure in response to the input signal, based on the model and the input signal.

A diagnostic device, according to an aspect of the present invention, includes: the analysis device; stress calculating means for calculating stress occurring in the structure, based on the response calculated by the response calculation means of the analysis device; and reliability evaluation means for evaluating reliability including catastrophic failure and wear failure of the structure, based on the stress.

An analysis method, according to an aspect of the present invention, includes: identifying a model representing time evolution of a structure using a non-Gaussian random process, based on response of the structure; generating a probability model representing a distribution of an input, based on data indicating fluctuation of the input to the structure; generating an input signal for the structure based on the probability model; and deriving random response of vibration occurring in the structure in response to the input signal, based on the model and the input signal.

A computer-readable recording medium, according to an aspect of the present invention, stores a program causing a computer to execute: processing of identifying a model representing time evolution of a structure using a non-Gaussian random process, based on response of the structure; processing of generating a probability model representing a distribution of an input, based on data indicating fluctuation of the input to the structure; processing of generating an input signal for the structure based on the probability model; and processing of deriving random response of vibration occurring in the structure in response to the input signal, based on the model and the input signal.

### Advantageous Effects of Invention

According to the present invention, it is possible to provide an analysis device or the like that enables highly accurate diagnosis of the state of a structure.

### BRIEF DESCRIPTION OF DRAWINGS

FIG. 1 is a figure illustrating a configuration of an analysis device of a first example embodiment of the present invention.

FIG. 2 is a figure illustrating a configuration of a diagnostic device of the first example embodiment of the present invention.

FIG. 3 is a figure illustrating a configuration of a diagnostic device and a data acquisition unit of the first example embodiment of the present invention.

FIG. 4 is a figure illustrating an example of modeling of a pipe to be analyzed by a one-degree-of-freedom structural model.

FIG. 5 is a figure illustrating an example of input fluctuation with respect to a structure and a probability model generated by an input modeling unit.

FIG. 6 is a figure illustrating an example of evaluation by a fatigue strength reliability evaluation unit.

FIG. 7 is a flow chart illustrating operation of the diagnostic device of the first example embodiment of the present invention.

FIG. 8 is a flowchart illustrating operation of system identification by the analysis device of the first example embodiment of the present invention.

FIG. 9 is a figure illustrating a configuration of a diagnostic device according to a modification of the first example embodiment of the present invention.

FIG. 10 is a figure illustrating an example of response distribution of vibration response estimated in an example.

FIG. 11 is a figure illustrating an example of displacement restoration force characteristics identified in the example.

FIG. 12 illustrates an example of a probability model for water pressure distribution estimated in the example.

FIG. 13 illustrates an example of stress and tensile strength evaluated in the example.

FIG. 14 illustrates an example of displacement restoration force characteristics identified when deterioration is assumed in the example.

FIG. 15 is a figure illustrating an example of an information processing apparatus for realizing an analysis device or the like of each example embodiment of the present invention.

### EXAMPLE EMBODIMENT

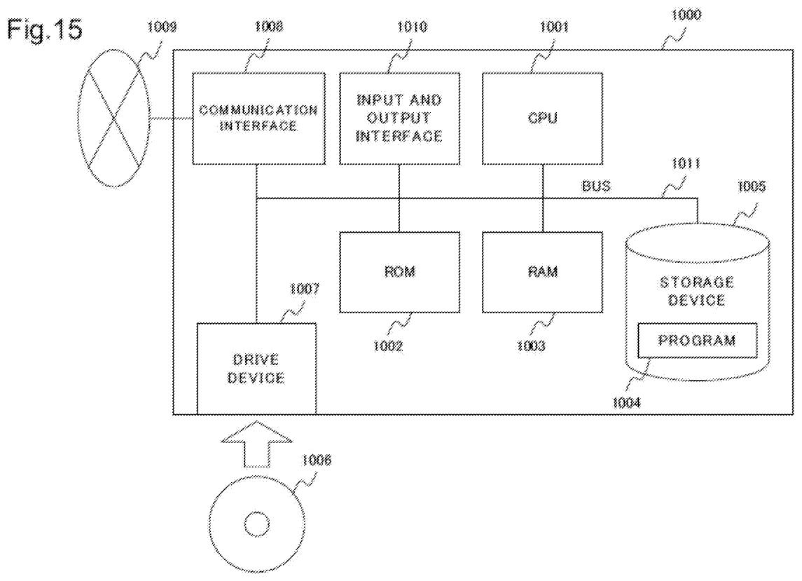

Example embodiments of the present invention will be described with reference to the accompanying drawings. In each example embodiment of the present invention, each constituent element of each device indicates a block of a functional unit. A part or all of constituent elements of each device is realized by any combination of an information processing device 1000 and a program as illustrated in FIG. 15, for example. The information processing device 1000 includes, for example, the following configuration.
CPU (Central Processing Unit) 1001
ROM (Read Only Memory) 1002
RAM (Random Access Memory) 1003
Program 1004 loaded to RAM 1003
Storage device 1005 storing program 1004
Drive device 1007 for reading and writing recording medium 1006
Communication interface 1008 connected to communication network 1009
Input and output interface 1010 for inputting and outputting data
Bus 1011 for connecting constituent elements

Each constituent element of each device in each example embodiment is realized by the CPU 1001 acquiring and executing the program 1004 that realizes these functions. The program 1004 for realizing the function of each constituent element of each device is stored in advance in, for example, the storage device 1005 or the RAM 1003, and read by the CPU 1001 as necessary. Note that the program 1004 may be supplied to the CPU 1001 via the communication network 1009 or may be stored in advance in the recording medium 1006, and the drive device 1007 may read the program and supply the program 1004 to the CPU 1001.

There are various modifications in the implementation method of each device. For example, each device may be realized by any combination of respective information processing devices 1000 and respective programs for constituent element. In addition, a plurality of constituent elements included in each device may be realized by any combination of an information processing device 1000 and a program.

In addition, a part or all of constituent elements of each device is realized by a general purpose or dedicated circuit (circuitry) including a processor or the like, or a combination thereof. These may be constituted by a single chip or may be constituted by a plurality of chips connected via a bus. A part or all of constituent elements of each device may be realized by a combination of the above-described circuits and the like and programs.

When a part or all of constituent elements of each device is realized by a plurality of information processing devices, circuits, and the like, the plurality of information processing devices, circuits, and the like may be arranged centrally or in a distributed manner. For example, the information processing devices, circuits, and the like may be realized as a form in which each is connected via a communication network, such as a client and server system, a cloud computing system, and the like.

Note that, in the following example embodiments, it is assumed that the structure is a water pipe which is one of pipes. However, the structure may be a pipe other than a water pipe, and is not limited to a pipe. In addition, each device in the following example embodiments may be directed to a structure other than a pipe, such as a water pipe.

### First Example Embodiment

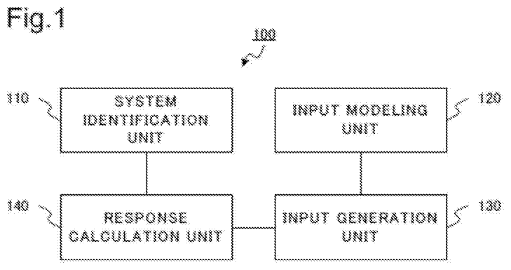

First, the first example embodiment of the present invention will be described. FIG. 1 is a view illustrating an analysis device of the first example embodiment of the present invention.

As illustrated in FIG. 1, the analysis device 100 of the first example embodiment of the present invention includes a system identification unit 110, an input modeling unit 120, an input generation unit 130, and a response calculation unit 140. The system identification unit 110 uses the non-Gaussian random process of the structure to identify a model representing time evolution of the structure based on the response of the structure. The input modeling unit 120 generates a probability model for the distribution of the input based on the data indicating the fluctuation of the input to the structure. The input generation unit 130 generates an input signal for the structure based on the probability model representing the distribution of the input for the structure. The response calculation unit 140 derives a random response of vibration occurring in the structure with respect to the input signal based on the model of the structure and the input signal to the structure.

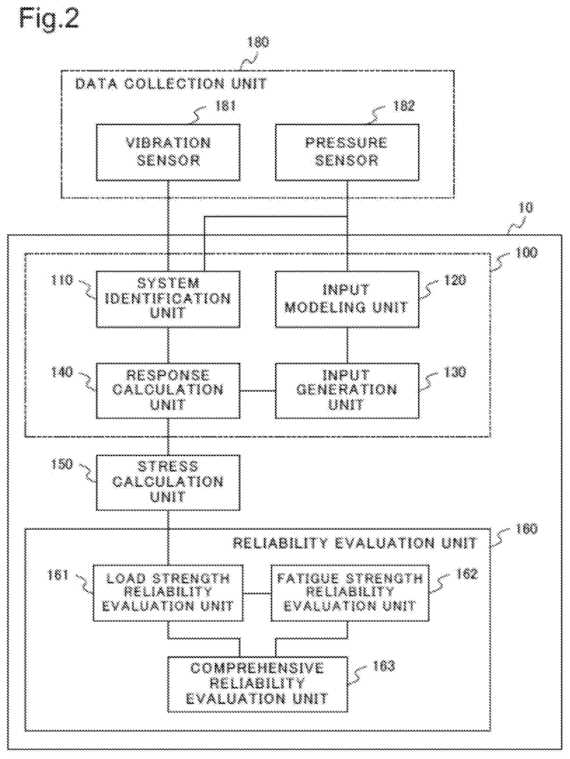

Further, as illustrated in FIG. 2, a diagnostic device 10 having an analysis device 100 is configured. The diagnostic device 10 includes an analysis device 100, a stress calculation unit 150, and a reliability evaluation unit 160. The stress calculation unit 150 derives the stress generated in the structural unit based on the response of the structure. As the response of the structure, a value obtained by the response calculation unit 140 is used. The reliability evaluation unit 160 evaluates the reliability of the structure based on the stress generated in the structure. As the stress, a value derived by the stress calculation unit 150 is used.

More specifically, the reliability evaluation unit 160 includes a load strength reliability evaluation unit 161 and a fatigue strength reliability evaluation unit 162. The load strength reliability evaluation unit 161 derives the load strength reliability indicating reliability about catastrophic failure of the structure. The fatigue strength reliability evaluation unit 162 derives fatigue strength reliability indicating reliability on wear failure of the structure. The comprehensive reliability evaluation unit 163 derives the reliability of the structure based on the load strength reliability indicating the reliability about the catastrophic failure of the structure and the fatigue strength reliability indicating the reliability of the wear failure.

The analysis device 100 and the diagnostic device 10 perform analysis and diagnosis using data collected by the data collection unit 180. The data collection unit 180 collects data indicating an input to the structure and a response to the input. When a pipe such as a water pipe is targeted, the data collection unit 180 includes, for example, a vibration sensor 181 and a pressure sensor 182. The vibration sensor 181 detects vibrations propagating in a pipe or a fluid such as water flowing inside the pipe. As the vibration sensor 181, for example, an eddy current displacement sensor, a Doppler velocity sensor, a piezoelectric acceleration sensor, or the like is used.

Pipes such as water pipes are vibrated by fluctuations in water pressure and external vibration. In other words, fluctuations in water pressure cause vibrations in the pipe. Fluctuations of water pressure are input to the structure, and vibration caused by the fluctuations of water pressure is the response of the structure. In the present example embodiment, each of the analysis device 100 and the diagnostic device 10 uses the fluctuations of water pressure as an input to the structure and analyzes the vibration generated due to the fluctuations of water pressure as a response.

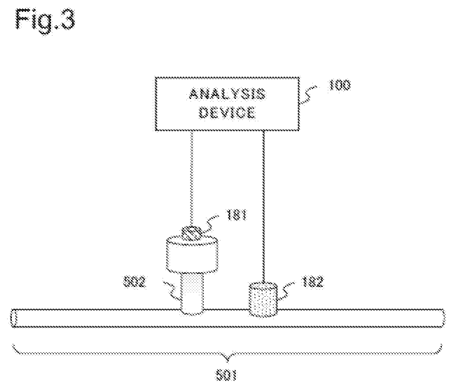

The pressure sensor 182 detects the pressure of the fluid flowing inside the pipe. As described above, fluctuations of pressure are an input to the structure. If the pipe is a water pipe, the pressure sensor 182 detects the water pressure. As illustrated in FIG. 3, the vibration sensor 181 is attached to a fire hydrant 502 or the like provided in the pipe 501. Also, the pressure sensor 182 is attached to, for example, the pipe 501.

When the structure is a water pipe, water pressure fluctuation of the water flowing through the water pipe occurs, for example, by releasing the water or controlling a pump provided in the water pipe. In this case, the vibration sensor 181 detects a vibration response which is a vibration generated by the water pressure fluctuation. In addition, the pressure sensor 182 detects water pressure fluctuation. By collecting data of thus detected water pressure fluctuation being the input, and vibration response, the analysis or diagnosis by the analysis device 100 and the diagnostic device 10 is performed.

Subsequently, constituent elements of the analysis device 100 and the diagnostic device 10 of the present example embodiment will be described. First, each constituent element of the analysis device 100 will be described.

The system identification unit 110 identifies a model representing the time evolution of the structure based on the response of the structure. In the present example embodiment, as described above, the structure is a pipe such as a water pipe. The system identification unit 110 uses a non-Gaussian random process to identify a structural model representing time evolution based on the probability model of a response to the structure such as a pipe.

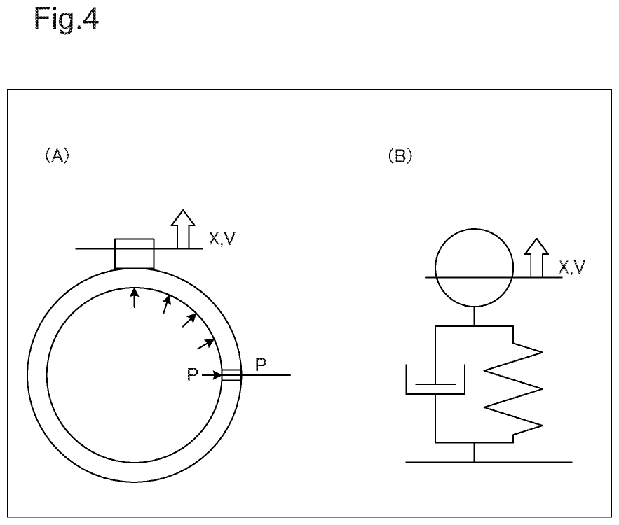

In the present example embodiment, as an example, it is assumed that the model of pipe is represented by a structural model of one degree of freedom based on the resonant frequency of a pipe. FIG. 4 illustrates an example of an assumed structural model. FIG. 4(A) is an example illustrating a cross section of a pipe to be modeled, and FIG. 4(B) is an example of a structural model of the pipe. In the example illustrated in FIG. 4(B), the structural model includes a spring and a damper. Hereinafter, as a specific example of the operation of the system identification unit 110, an example in which the system identification unit 110 identifies a structural model illustrated in FIG. 4(B) will be described. In FIG. 4(A), P denotes water pressure, X denotes displacement of vibration response of a structural model, and V denotes velocity of vibration response of the structural model.

Note that, in the present example embodiment, it is assumed that the pipe which is a target of identification of the structural model illustrated in FIG. 4(B) is a cast iron pipe. Also, in consideration of the material characteristics of cast iron, the pipe is assumed to have non-linear restoration force characteristics. It is assumed that water pressure fluctuation represented by Gaussian white noise is added as water pressure fluctuation input to pipe. However, targets for the analysis device 100 and the like including the system identification unit 110 and the system identification unit 110 are not limited to such a pipe. Also, the input is not limited to the Gaussian input.

The system identification unit 110 treats the equation of motion of the structural model as a stochastic process which is non-deterministic. In the present example embodiment, the system identification unit 110 represents a structural model by using the Fokker-Planck equation. The Fokker-Planck equation is an equation of motion that represents the time evolution of the probability density function with respect to displacement and velocity of vibration of a structure. In other words, the system identification unit 110 identifies a model representing temporal changes in the probability density function of the velocity and the displacement of the vibration of the structure as a model representing the time evolution of the structure. In the system identification unit 110, identification of a structural model based on the following equation (1) can be considered as an example.

$$\begin{matrix} [ Equation 1 ] & \\ \frac{\partial f ( {x}_{1} , {x}_{2} , t )}{\partial t} = - {x}_{2} \frac{\partial f ( {x}_{1} , {x}_{2} , t )}{\partial {x}_{1}} + ( {kx}_{1} + {cx}_{2} + ɛ {x}_{1}^{2} + μ {x}_{1}^{3} ) \frac{\partial f ( {x}_{1} , {x}_{2} , t )}{\partial {x}_{2 }} + cf ( {x}_{1} , {x}_{2} , t ) + D \frac{{\partial }^{2} f ( {x}_{1} , {x}_{2} , t )}{\partial {x}_{2}^{2}} & ( 1 )\end{matrix}$$

In the equation (1), x₁ denotes a probability variable of displacement of a structural model, x₂ denotes a probability variable of speed of the structural model, and t denotes time. x₁ corresponds to the above-described X, and x₂ corresponds to the above-described V. f(⋅) represents a probability density function having ⋅ as a probability variable. Also, k denotes a spring constant of the structural model, and c denotes a damping coefficient of the damper of the structural model. Also, in equation (1), terms up to the third order regarding displacement are considered. ε denotes a second-order nonlinear coefficient, and μ denotes a third-order nonlinear coefficient. D denotes a diffusion coefficient of water pressure fluctuation which is an input. D is obtained by deriving the probability density of the input based on the detection result by the pressure sensor 182 and the like.

Derivation of the theoretical solution of the Fokker-Planck equation may be difficult in general. Thus, in the present example embodiment, the system identification unit 110 identifies a model based on a moment equation describing the time evolution of the moment with respect to the probability density function. E[x] denotes the moment for the probability density function f(x).

And, the moment equation corresponding to equation (1) is expressed as equation (2). Note that, in equation (2), each of i and j represents the order of moment.

$$\begin{matrix} [ Equation 2 ] & \\ \frac{dE [ {x}_{1}^{i} {x}_{2}^{j} ]}{dt} = E [ {x}_{2} \frac{\partial ( {x}_{1}^{i} {x}_{2}^{j} )}{\partial {x}_{1}} ] - E [ ( {kx}_{1} + {cx}_{2} + ɛ {x}_{1}^{2} + μ {x}_{1}^{3} ) \frac{\partial ( {x}_{1}^{i} {x}_{2}^{j} )}{\partial {x}_{2 }} ] + DE [ \frac{{\partial }^{2} ( {x}_{1}^{i} {x}_{2}^{j} )}{\partial {x}_{2}^{2}} ] & ( 2 )\end{matrix}$$

Equation (2) is a linear equation for unknown parameters k, c, ε, μ, Also, the displacement, velocity, and the like of vibration obtained by the vibration sensor 181 correspond to the response of these structural models to the fluctuation of water pressure which is input. That is, if the probability density function of the response is obtained based on the vibration detected by the vibration sensor 181, the values of the high-order moments of equation (2) is determined. And the unknown parameter described above is derived by applying the least squares method to the simultaneous equations including high-order moments.

Note that, the probability density function f(x₁, x₂) of response is decomposed as in the following equation (3), and the moment thereof can be obtained as in the following equation (4). In equation (3), 0, represents a parameter of each distribution.

[Equation 3]

f(x₁,x₂)=f₁(x₁|θ₁)*f₂(x₂|θ₂) (3)

[Equation 4]

E[x₁x₂]=E[x₁]E[x₂] (4)

The n-th moment is defined by the following equation (5).

[Equation 5]

E[xⁿ]=∫_{-∞}^{∞}xₙf(x)dx (5)

In addition, in the case of obtaining the probability density function of response, it is preferable that non-Gaussianity be considered for the input to the structural model and the response of the structural model. Therefore, the probability density function of response can be obtained by using EM (Expectation-Maximization) algorithm using mixture Gaussian model, latent distribution estimation algorithm using heterogeneous mixture learning, and the like. The system identification unit 110 obtains a moment by using the probability density function obtained by these algorithms.

The simultaneous equations for obtaining the above-described unknown parameters are expressed as equation (6) as an example. In the equation (6), the moments up to the fourth order are considered. Further, Equation (6) shows the case where the second-order nonlinear coefficient is zero. Note that, in the equation (6), the order of the moment to be considered is not limited up to the fourth order. The order of the moment to be considered may be appropriately determined in accordance with various factors such as the type of the structure to be processed.

$$\begin{matrix}[ Equation 6 ] & \\ Y = X \cdot θ \\ X = [ \begin{matrix}E [ {x}_{1}^{2} ] & 0 & E [ {x}_{1}^{4} ] \\ E [ {x}_{1}^{4} ] & 0 & E [ {x}_{1}^{6} ] \\ 0 & E [ {x}_{1}^{2} {x}_{2}^{2} ] & 0 \\ 3 E [ {x}_{1}^{2} {x}_{2}^{2} ] & 0 & 3 E [ {x}_{1}^{4} {x}_{2}^{2} ] \\ 0 & E [ {x}_{2}^{4} ] & 0\end{matrix} ] , \\ Y = [ \begin{matrix}E [ {x}_{2}^{2} ] \\ 3 E [ {x}_{1}^{2} {x}_{2}^{2} ] \\ E [ {x}_{1}^{2} ] D \\ E [ {x}_{2}^{4} ] \\ 3 E [ {x}_{2}^{2} ] D\end{matrix} ] , θ = [ \begin{matrix}k \\ c \\ μ\end{matrix} ] & ( 6 )\end{matrix}$$

Then, by applying the least squares method to equation (6), equation (7) illustrated below is obtained.

[Equation 7]

θ=(X^{T}X)⁻¹X^{T}Y (7)

By using the equation (7), the unknown parameters k, c and μ described above can be obtained. The derived values are applied to equation (1), so that a structural model is identified.

The input modeling unit 120 models the input signal based on data indicating the fluctuation of the input to the structure. Specifically, the input modeling unit 120 generates a probability model that represents the distribution of the input.

When the structure is a pipe such as a water pipe, fluctuation of pressure of fluid such as water flowing inside is an input to the pipe. That is, the input modeling unit 120 generates, for example, a probability model of water pressure distribution.

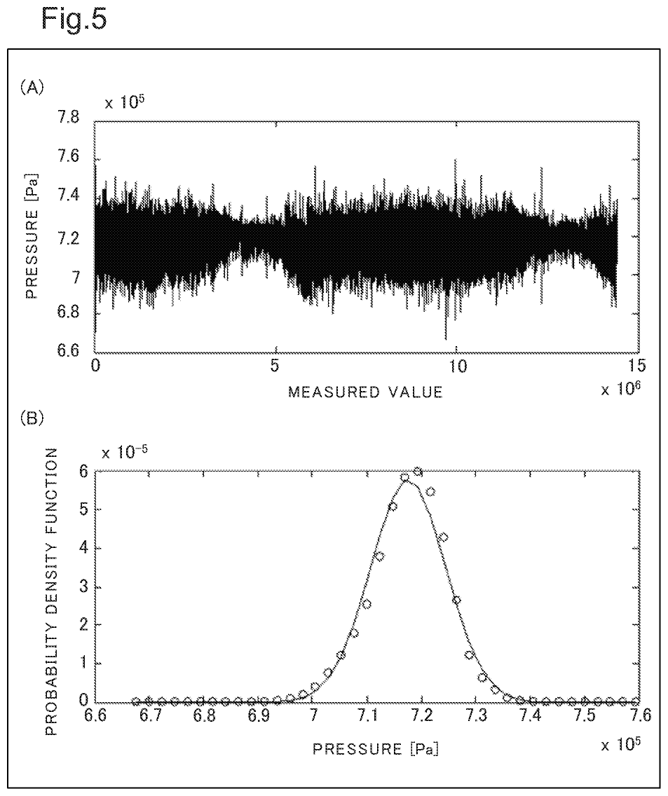

The input modeling unit 120 generates a probability model representing a water pressure distribution, which is input, based on data indicating fluctuations of water pressure for several days detected by, for example, the pressure sensor 182. Preferably, the data used to generate the probability model is data sensed and collected by pressure sensor 182 over two or more days. However, the period of data collection is not particularly limited, and may be determined according to the required accuracy, the period in which data can be collected, and the like. FIG. 5(A) illustrates an example of data showing fluctuation of water pressure which is input.

Note that the distribution of water pressure generally follows a Gaussian distribution, but may have non-Gaussianity. However, in the input modeling unit 120, the distribution of water pressure may be treated as a Gaussian distribution. Also, in the input modeling unit 120, the distribution of water pressure may be treated as a non-Gaussian process.

The input modeling unit 120 generates a probability model of the input, for example, using a known algorithm, based on the data of the fluctuation of water pressure collected as described above. In the input modeling unit 120, an EM algorithm using a mixture Gaussian model, a latent distribution algorithm by heterogeneous mixture learning, or the like is used. FIG. 5(B) illustrates an example of the probability model generated by the input modeling unit 120.

The input generation unit 130 generates an input signal for the structure based on the probability model of the input to the structure modeled by the input modeling unit 120. The input generation unit 130 generates an input signal by solving the probability model generated by the input modeling unit 120 with respect to the probability variable and providing random numbers generated using a uniform distribution. The generated input signal is, for example, a signal representing a change in water pressure for a fixed time.

The response calculation unit 140 derives distribution of a random response of the vibration occurring in the structure with respect to the input signal on the basis of the model of the structure identified by the system identification unit 110 and the input signal to the structure generated by the input generation unit 130

The response calculation unit 140 uses, for example, a known numerical integration method such as the Runge-Kutta method to obtain a random response to the input signal. That is, the response calculation unit 140 numerically integrates, according to the method described above, the input signal, which is a random signal generated by the input generation unit 130, which is in accordance with the distribution of the probability model generated by the input modeling unit 120, to obtain the distribution of random responses of structure. As a model of structure, a model identified based on the parameters k, c, and μ obtained as described above is appropriately used.

Next, each constituent element of the diagnostic device 10 will be explained.

The stress calculation unit 150 obtains the stress occurring in the structure such as a pipe based on the random response of the structure obtained by the response calculation unit 140.

The relationship between displacement of structure and stress is expressed by the following equation (8) as an example.

$$\begin{matrix}[ Equation 8 ] & \\ σ = \frac{M}{AR} = \frac{Eh}{12 ( 1 - {v}^{2} ) {AR}^{3}} ( \frac{\partial {U}_{θ}}{\partial θ} - \frac{{\partial }^{2} {U}_{r}}{\partial {θ}^{2 }} ) & ( 8 )\end{matrix}$$

In equation (8), Uᵣ represents the vertical displacement of pipe. Uᵣ corresponds to the distribution of displacements detected by the vibration sensor 181 and the distribution of random responses of displacements of the structure obtained by the response calculation unit 140. U₀ represents the circumferential displacement of the pipe, and the relational equation can be obtained by specifying the shape function of the pipe. When a function of a cosine function w=w₀*cos 2θ is used as the shape function of w, a relation of U₀=−U₀₀*sin 2θ/2 is obtained. The stress is derived by substituting these into the differential operation of equation (8) and setting θ=0. Also, R denotes the radius of the pipe, E denotes the elastic modulus of the pipe, h denotes the wall thickness of the pipe, A denotes the cross-sectional area of the pipe, and L denotes the length of the pipe. For A, h and L, a relationship A=hL holds. v denotes Poisson's ratio.

The reliability evaluation unit 160 evaluates the reliability of the structure based on the distribution of stress occurring in the structure derived by the stress calculation unit 150. The reliability evaluation unit 160 comprehensively evaluates catastrophic failure and wear failure of the structure such as a pipe or the like.

The failure of the structure may be explained by reliability theory. In this case, it is necessary to evaluate reliability regarding both catastrophic failure and wear failure in the structure in service. The reliability regarding catastrophic failure is expressed, for example, using a known load strength model. The load strength model is determined based on the strength of the structure and the probability that load is applied to the structure for the first time. The reliability regarding wear failure is expressed using the load cycle model or the extreme value statistical model. The reliability evaluation unit 160 evaluates each of the reliability of catastrophic failure and wear failure of the structure of the pipe or the like. The reliability evaluation unit 160 then evaluates the reliability with respect to the strength of the structure on the basis of the evaluated reliability regarding the catastrophic failure and the wear.

As described above, the reliability evaluation unit 160 includes the load strength reliability evaluation unit 161, the fatigue strength reliability evaluation unit 162, and the comprehensive reliability evaluation unit 163.

The load strength reliability evaluation unit 161 derives load strength reliability. More specifically, the load strength reliability evaluation unit 161 derives load strength reliability of a structure such as a pipe by using a load strength model based on the distribution of stress. As the load strength model, as described above, a known model is suitably used. The reliability derived by the load strength reliability evaluation unit 161 is related to the reliability of catastrophic failure. Hereinafter, the reliability represented by load strength reliability evaluation unit 161 is denoted as R₁.

The fatigue strength reliability evaluation unit 162 derives fatigue strength reliability. More specifically, the fatigue strength reliability evaluation unit 162 derives fatigue strength of the structure such as a pipe on the basis of stress distribution and fatigue strength of the structure by using a method such as rain flow method. The reliability derived by the fatigue strength reliability evaluation unit 162 is related to the reliability of wear failure. Hereinafter, the reliability represented by fatigue strength reliability evaluation unit 162 is denoted as R₂.

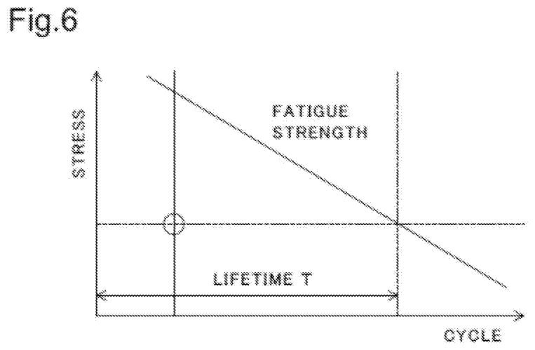

As illustrated in FIG. 6, the structure fatigue strength is expressed as the relationship between the number of cycles in which stress is applied to the structure and the magnitude of the amplitude of the stress permitted in the number of cycles. The fatigue strength reliability evaluation unit 162 decomposes the amplitude and the frequency in the process of stress, and derives a lifetime of the structure by adopting, as the lifetime, the number of cycles corresponding to the most frequent amplitude of stress in the distribution of stress, on the relationship for the fatigue strength. And the fatigue strength reliability evaluation unit 162 derives a reliability R₂ on the basis of the following equation (9) with the reciprocal of the lifetime being a failure rate. Note that T denotes the number of cycles with which the end of the lifetime comes, and t denotes time.

$$\begin{matrix}[ Equation 9 ] & \\ {R}_{2} ( t ) = exp ( - \frac{t}{T} ) & ( 9 )\end{matrix}$$

The comprehensive reliability evaluation unit 163 evaluates the reliability of the structure on the basis of the evaluation result of reliability of catastrophic failure derived by the load strength reliability evaluation unit 161 and the evaluation result of reliability of wear failure derived by the fatigue strength reliability evaluation unit 162.

When the structure is a pipe, a failure of the pipe may lead to a stoppage of functions when either catastrophic failure or wear failure occurs. That is, leakage or the like of the pipe may occur and replacement of the pipe may be necessary in the case of either catastrophic failure or wear failure.

Therefore, in the present example embodiment, the reliability evaluation unit 160 derives the reliability in which both catastrophic failure and wear failure are considered for the structure of the pipe or the like. More specifically, the reliability evaluation unit 160 derives the reliability by using the following equation (10). That is, the reliability evaluation unit 160 adopts the product of two reliabilities as a comprehensive reliability in which both catastrophic failure and wear failure are considered for the structure of the pipe or the like.

[Equation 10]

R=R₁×R₂ (10)

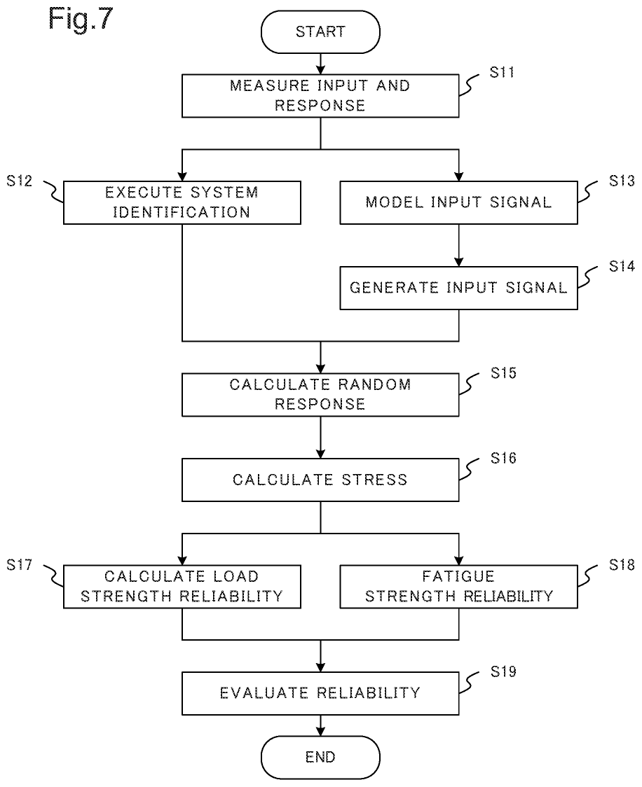

Subsequently, operations of the analysis device 100 and the diagnostic device 10 will be described with reference to the flowchart illustrated in FIG. 7.

First, the data collection unit 180 measures the input and response of a structure (step S11). As illustrated in FIG. 3, when the structure is a pipe, the pressure sensor 182 measures the fluctuation of the water pressure input to the pipe, and the vibration sensor 181 measures the vibration that is the response of the pipe. The analysis device 100 and the diagnostic device 10 acquire data measured via a wired or wireless communication network or any type of recording medium.

The processing from step S12 to step S15 is mainly performed by each element of the analysis device 100. First, system identification unit 110 executes system identification of the structure (step S12). Details of the process to be executed will be described later.

The input modeling unit 120 models the input signal (step S13). That is, the input modeling unit 120 generates a probability model of the input signal on the basis of data indicating the water pressure fluctuation or the like detected by the pressure sensor 182 of the data collection unit 180.

Subsequent to step S13, the input generation unit 130 generates an input signal to be applied to the structure by using the probability model generated in step S13 (step S14).

Note that the order of execution of the two processes, i.e., the process of step S12 and the process of step S13 and S14 is not limited. These processes may be performed in parallel as illustrated in the flowchart in FIG. 7. Also, these processes may be performed sequentially in an arbitrary order.

Subsequently, the response calculation unit 140 calculates a random response of the structure (step S15). The response calculation unit 140 calculates the distribution of random response by using a known method or the like on the basis of the input signal to the structure obtained in step S14 and the model of the structure generated in step S12. In step S15, the response calculation unit 140 derives at least the distribution of response relating to displacement.

The stress calculation unit 150 calculates the distribution of stress occurring in the structure on the basis of the random response obtained in step S15 (step S16). The stress calculation unit 150 mainly derives the distribution of stress on the basis of the distribution of displacement obtained in step S15.

Subsequently, in the process from step S17 to step S19, the reliability evaluation unit 16 evaluates reliability of the structure.

First, the load strength reliability evaluation unit 161 evaluates load strength reliability (step S17). That is, the load strength reliability evaluation unit 161 evaluates reliability of catastrophic failure.

The fatigue strength reliability evaluation unit 162 evaluates fatigue strength reliability (step S18). That is, the fatigue strength reliability evaluation unit 162 evaluates reliability of wear failure.

Note that the order of execution of the processing of step S17 and the processing of step S18 is not limited. These processes may be performed in parallel, as in the flowchart illustrated in FIG. 7, or, these processes may be performed sequentially in any order.

Subsequently, the comprehensive reliability evaluation unit 163 evaluates the reliability of the structure on the basis of the load strength reliability obtained at step S17 and the fatigue strength reliability obtained at step S18. (step S19).

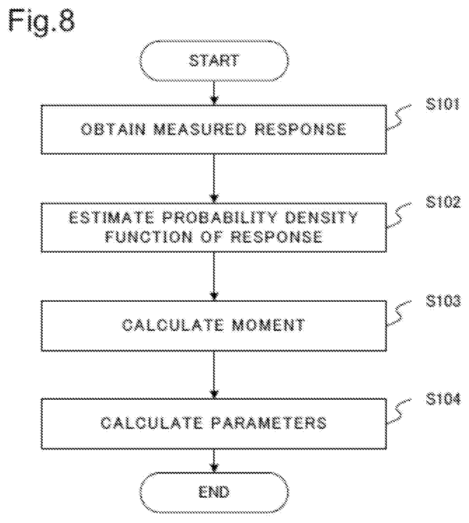

Also, system identification in step S12 is performed in accordance with the flowchart illustrated in FIG. 8. The operation of system identification by the system identification unit 110 will be described with reference to the flowchart illustrated in FIG. 8.

First, the system identification unit 110 obtains the data of the vibration measured by the vibration sensor 181 of the data collection unit 180 in the structure that is the target of system identification (step S101).

Subsequently, the system identification unit 110 estimates a probability density function of response based on the data of the vibration measured by step S101 (step S102).

Subsequently, the system identification unit 110 calculates a moment of the probability density function by using the probability density function of the response estimated in step S102 (step S103). In this case, the system identification unit 110 calculates higher order moments up to a predetermined order. Also, the system identification unit 110 may receive a specification of the maximum order of the higher order moments.

Subsequently, the system identification unit 110 calculates parameters relating to the above-described structural model (step S104). By calculating the parameters, a structural model of the structure is identified.

As described above, the analysis device 100 of the present example embodiment identifies a model representing the time evolution of the structure using a non-Gaussian random process based on the distribution of the response of the structure. Then, based on the model representing the time evolution, the analysis device 100 obtains, as a distribution, the response to the input applied to the structure and the stress occurring in the structure.

In the case of a model in the range of Gaussianity where nonlinearity is not considered, the response distribution, that is, the stress distribution may be overestimated if the structure has a gradually harden spring characteristic. Also, in such a model, the stress distribution may be underestimated if the structure has a gradually soften spring characteristic. As a result, the reliability R described above for the structure may not be evaluated correctly.

On the other hand, in the analysis device 100, a non-Gaussian model is identified. Therefore, the problems described above can be avoided. In addition, since catastrophic failure is represented by a load strength model, it is possible to evaluate reliability for catastrophic failure by realizing the stress evaluation and strength evaluation as described above.

Therefore, by using the results obtained by the analysis device 100, it is possible to accurately evaluate the reliability in view of not only the wear failure but also the catastrophic failure. That is, the analysis device 100 and the diagnostic device 10 enable highly accurate diagnosis of the state of the structure.

(Modification)

Modifications can be considered for the analysis device 100 and the diagnostic device 10 shown in the above-mentioned example embodiment. Some of the modifications are illustrated below.

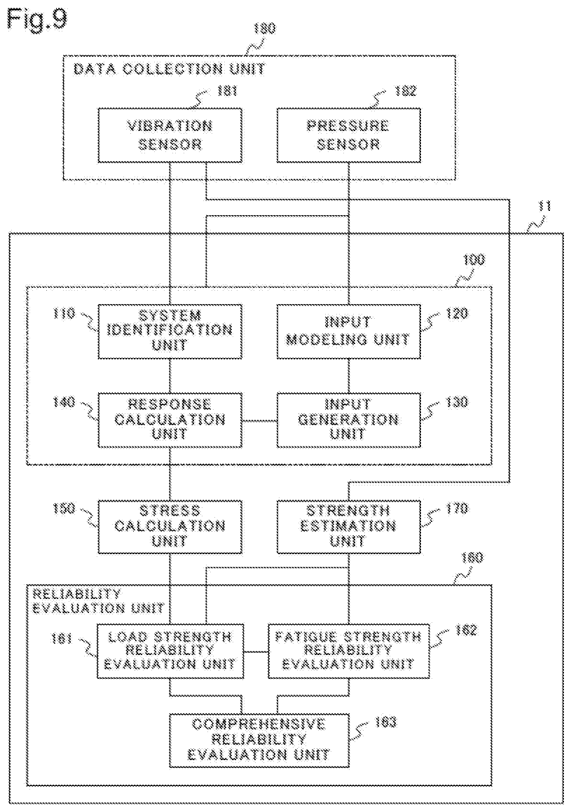

FIG. 9 illustrates a configuration of a diagnostic device 11 according to a modification of the example embodiment described above. As illustrated in FIG. 9, the diagnostic device 11 differs from the diagnostic device 10 in that it has a strength estimation unit 170 as compared with the diagnostic device 10 described above.

The strength estimation unit 170 estimates the strength of the structure when the data is collected, based on the vibration of the structure detected by the vibration sensor 181. The strength estimation unit 170 derives estimated tensile strength and the estimated fatigue strength of the structure when data is collected, by using a known method as appropriate. In this case, the strength estimation unit 170 derives, for example, the distribution of these values of strength.

And, in this modification, the load strength reliability evaluation unit 161 evaluates load strength reliability of the structure on the basis of the distribution of the estimated tensile strength of the structure estimated by the strength estimation unit 170 and the distribution of the stress derived by the stress calculation unit 150. Similarly, the fatigue strength reliability evaluation unit 162 evaluates the fatigue strength of the structure on the basis of the distribution of estimated fatigue strength of the structure estimated by strength estimation unit 170 and the distribution of the stress derived by stress calculation unit 150.

As described above, also in the case where the strength estimation unit 170 is provided, the diagnostic device 11 has the same effect as the diagnostic device 10.

### EXAMPLE

The diagnostic device 10 described above was applied to the diagnosis of reliability of structure. In this example, an experiment was conducted to diagnose the reliability for the water pipe after use. A normal gray cast iron pipe with a diameter of 100 mm (millimeter) and a length of 5 m (meter) was used as the water pipe. Water was passed with a test rig to the water pipe to be tested.

The water pipe to be tested had fire hydrants at both ends and was closed at the ends. There was no flow in the water inside the water pipe.

In addition, a pressure pump was installed upstream of the water pipe. And a hydrodynamic pressure shaker was installed in the fire hydrant on the upstream side. An eddy current displacement sensor and a laser doppler vibrometer were installed as a vibration sensor 181 at the fire hydrant on the downstream side. Also, a hydrodynamic pressure sensor was installed as a pressure sensor 182 at the fire hydrant on the downstream side.

With respect to the water pipe described above, the water pipe was vibrated by generating a white noise sequence using a hydrodynamic pressure shaker with the hydrostatic pressure of the water passed through inside as 0.6 MPa (Mega Pascal). And, the vibration response and the hydraulic pressure response to the vibration by the hydrodynamic pressure shaker were measured by each sensor mentioned above. In this case, the measurement of the vibration response was performed under the condition that the measurement range was ±10 V (volts), the number of bits for AD (Analog-to-digital) conversion was 16 bits, and the sampling frequency was 3 kHz. The measurement was performed for 5,000 seconds.

Based on the data measured by the eddy current displacement sensor and the laser Doppler vibrometer, the system identification unit 110 derived the probability density function of the vibration response. In this case, the system identification unit 110 fitted the vibration response to the mixed Gaussian model of third order. The system identification unit 110 used the EM algorithm to estimate the probability density function. And the convergence of the estimated value of the parametric parameter was confirmed by repeating 25 steps.

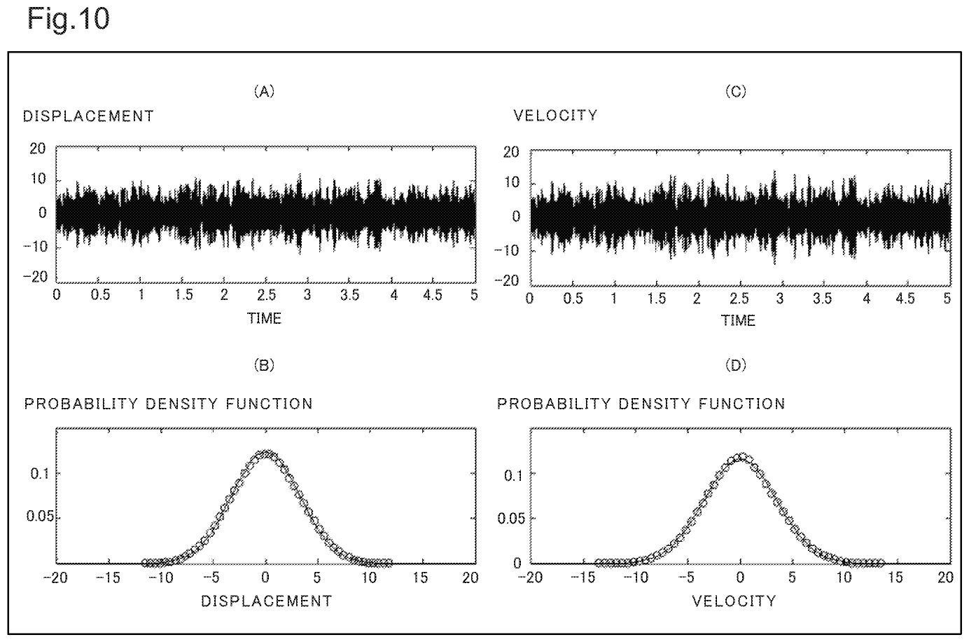

FIG. 10 illustrates an example where the vibration response is fitted to the mixed Gaussian model of third order. That is, FIG. 10(A) illustrates displacement of the measured vibration response, and FIG. 10(B) illustrates a probability density function of the distribution of displacement estimated based on the measured value. FIG. 10(C) illustrates measured velocity of vibration response, and FIG. 10(D) illustrates a probability density function of the distribution of the velocity estimated based on the measured value.

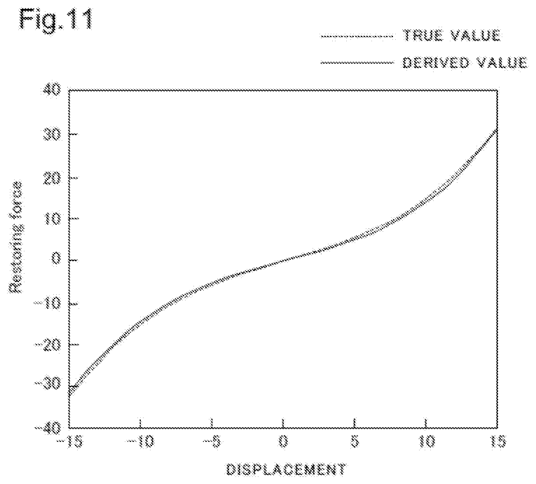

Subsequently, the system identification unit 110 derived the high-order moments from the probability density function derived. Then, the system identification unit 110 identified the model based on equation (7), using the higher order moments derived. FIG. 11 illustrates the displacement restoration force characteristic identified by the system identification unit 110. In FIG. 11, a broken line indicates a true value which is the actual value obtained by the sensor, and a solid line indicates a value obtained using the identified model.

As illustrated in FIG. 11, the difference between the two values was small, and it was confirmed that the identified model and the behavior of the actual water pipe were in good agreement. That is, it was confirmed that a restoration force characteristic including nonlinearity was obtained with regard to the identified model.

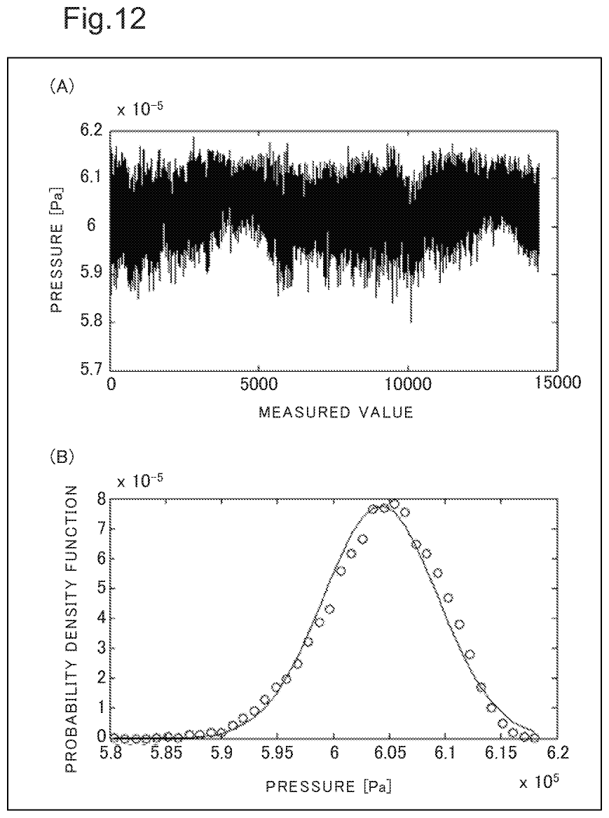

Then, the input modeling unit 120 performed the probability modeling of the water pressure distribution that was input. As data of water pressure fluctuation, data for 2 days measured in a cast iron pipe of the same diameter and made of the same material was used. The input modeling unit 120 used EM algorithm for univariate Gaussian distribution in modeling. Then, it was confirmed that the estimation of the parametric parameters converged by repeating the 5 steps. FIG. 12 illustrates an example of water pressure distribution and probability model. FIG. 12(A) is the measured water pressure distribution. Also, FIG. 12(B) illustrates an example of the probability model estimated by the input modeling unit 120 based on the water pressure distribution illustrated in FIG. 12(A).

And the response calculation unit 140 derived the response of the water pipe by using the probability model described above. The stress calculation unit 150 derived the stress occurring in the water pipe based on the response obtained by the response calculation unit 140.

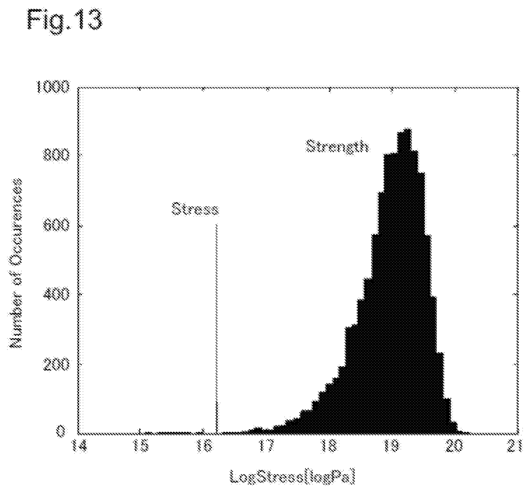

When stress was derived, the reliability evaluation unit 160 evaluated the reliability. Note that, in addition, the reliability evaluation unit 160 used the value of the tensile strength described in ‘Jesson D A, Mohebbi H, Farrow J, Mulheron M J, Smith P A. (2013), “On the condition assessment of cast iron trunk main: The effect of microstructure and in-service graphitisation on mechanical properties in flexure”, Materials Science and Engineering A, 576, pp. 192-201.’ for evaluation of the reliability. FIG. 13 illustrates the result of deriving the relationship between stress and tensile strength, which is derived by comparing with the value of tensile strength described in the above-mentioned document.

The load strength reliability evaluation unit 161 derived load strength reliability R₁ as R₁=0.99995. The fatigue strength reliability evaluation unit 162 derived fatigue strength reliability R₂ as R₂=0.999997. Then, based on the reliability R₁ and R₂, the reliability evaluation unit 160 derived the reliability to be R=0.999947 using the above-mentioned equation (10).

The derived reliability R was calculated as a value smaller than load strength reliability R₁. Therefore, it was confirmed that the reliability was evaluated on the safe side by the diagnostic device 10. That is, it was confirmed that the reliability was evaluated so that it is less likely to fail to notice that the water pipe stops functioning by failure.

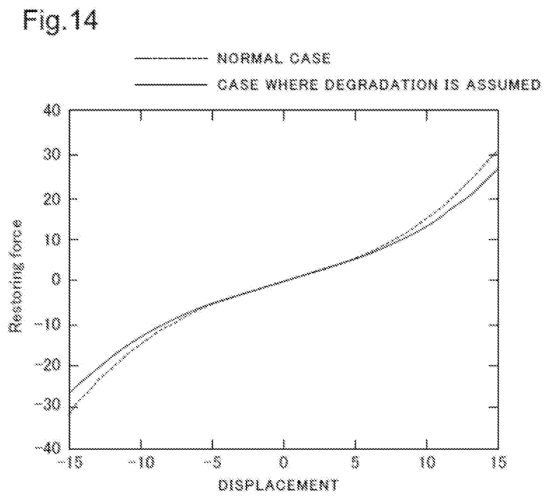

Subsequently, with respect to the structural model identified in the system identification unit 110, the evaluation of the reliability in the case of simulating the deterioration was further performed. In this case, as an example of the deterioration, the value of the spring constant k included in the structural model obtained by the system identification unit 110 was reduced by 5% (percent). An example of the structural model in this case is illustrated in FIG. 14. Using the modified structural model, the response calculation unit 140 derived the response of the water pipe, and the stress calculation unit 150 derived the stress occurring in the water pipe based on the response.

Then, the reliability evaluation unit 160 evaluated the reliability based on the stress obtained using the modified structural model. In this case, the load strength reliability evaluation unit 161 derived load strength reliability R₁ as R₁=0.99994. The fatigue strength reliability evaluation unit 162 derived fatigue strength reliability R₂ as R₂=0.999994. And the reliability evaluation unit 160 calculated reliability as R=0.999934 using the equation (10) explained above based on reliability R₁ and R₂.

In this case, the obtained value of reliability R was smaller than the reliability R in the previous example. In other words, it was confirmed that the diagnostic device 10 properly evaluated the deterioration degree according to the state of deterioration.

Also in this case, the reliability R was obtained as a smaller value than load strength reliability R₁. Therefore, it was confirmed that the reliability is evaluated on the safe side by the diagnostic device 10, as in the previous example. In other words, it was also confirmed that, even in the case of simulating the deterioration, the reliability is evaluated so that it is less likely to fail to notice that the water pipe stops functioning by failure.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims. Also, the configurations of the example embodiments and examples can be combined with each other without departing from the scope of the present invention.

This application is based upon and claims the benefit of priority from Japanese patent application No. 2017-70399, filed on Mar. 31, 2017, the disclosure of which is incorporated herein in its entirety by reference.

The whole or part of the example embodiments disclosed above can be described as, but not limited to, the following supplementary notes.

### (Supplementary Note 1)

An analysis device including:

system identification means for identifying a model representing time evolution of a structure using a non-Gaussian random process, based on a distribution of response of the structure;

input modeling means for generating a probability model representing a distribution of an input, based on data indicating fluctuation of the input to the structure;

input generation means for generating an input signal for the structure based on the probability model; and

response calculation means for deriving random response of vibration occurring in the structure in response to the input signal, based on the model and the input signal.

### (Supplementary Note 2)

The analysis device according to Supplementary Note 1, wherein the system identification means identifies the model, based on a probability density function of displacement and velocity of the vibration which is the response.

### (Supplementary Note 3)

The analysis device according to Supplementary Note 2, wherein the system identification means identifies the model representing time evolution of the probability density function of the displacement and the velocity of the vibration.

### (Supplementary Note 4)

The analysis device according to Supplementary Note 2 or 3, wherein the system identification means identifies the model, based on moment of the probability density function of the displacement and the velocity of the vibration.

### (Supplementary Note 5)

The analysis device according to any one of Supplementary Notes 1 to 4, wherein the structure is a pipe.

### (Supplementary Note 6)

The analysis device according to Supplementary Note 5, wherein the input modeling means generates the probability model representing the distribution of pressure based on the pressure fluctuation of the fluid flowing through the pipe collected in a predetermined time period.

### (Supplementary Note 7)

The analysis device according to Supplementary Note 6, wherein the input generation means generates the input signal representing fluctuation of the pressure, based on the probability model.

### (Supplementary Note 8)

The analysis device according to Supplementary Note 7, wherein the response calculation means derives the random response of vibration occurring in the structure in response to the fluctuation of the pressure represented by the input signal.

### (Supplementary Note 9)

A diagnostic device including: the analysis device according to any one of Supplementary Notes 1 to 8;

stress calculating means for calculating stress occurring in the structure, based on the response calculated by the response calculation means of the analysis device; and

reliability evaluation means for evaluating reliability including catastrophic failure and wear failure of the structure, based on the stress.

### (Supplementary Note 10)

The diagnostic device according to Supplementary Note 9, wherein the reliability evaluation means comprises:

load strength reliability evaluation means for evaluating load strength reliability indicating reliability with respect to catastrophic failure of the structure;

fatigue strength reliability evaluation means for evaluating fatigue strength reliability indicating reliability with respect to wear failure of the structure; and

comprehensive reliability evaluation means for evaluating reliability of the structure, based on the load strength reliability and the fatigue strength reliability.

### (Supplementary Note 11)

The diagnostic device according to Supplementary Note 10, wherein the load strength reliability evaluation means evaluates the load strength reliability, based on the stress and relationship between the stress and strength of the structure.

### (Supplementary Note 12)

The diagnostic device according to Supplementary Note 10, wherein the comprehensive reliability evaluation means evaluates the fatigue strength reliability, based on the stress and fatigue strength of the structure.

### (Supplementary Note 13)

The diagnostic device according to any one of Supplementary Notes 10 to 12, wherein the comprehensive reliability evaluation means derives the reliability of the structure, based on a product of the load strength reliability and the fatigue strength reliability.

### (Supplementary Note 14)

An analysis method including: identifying a model representing time evolution of a structure using a non-Gaussian random process, based on response of the structure;

generating a probability model representing a distribution of an input, based on data indicating fluctuation of the input to the structure;

generating an input signal for the structure based on the probability model; and

deriving random response of vibration occurring in the structure in response to the input signal, based on the model and the input signal.

### (Supplementary Note 15)

A computer-readable recording medium storing a program for causing a computer to execute:

processing of identifying a model representing time evolution of a structure using a non-Gaussian random process, based on response of the structure;

processing of generating a probability model representing a distribution of an input, based on data indicating fluctuation of the input to the structure;

processing of generating an input signal for the structure based on the probability model; and

processing of deriving random response of vibration occurring in the structure in response to the input signal, based on the model and the input signal.

### REFERENCE SIGNS LIST

10 diagnostic device
100 analysis device
110 system identification unit
120 input modeling unit
130 input generation unit
140 response calculation unit
150 stress calculation unit
160 reliability evaluation unit
161 load strength reliability evaluation unit
162 fatigue strength reliability evaluation unit
163 comprehensive reliability evaluation unit
170 strength estimation unit
180 data collection unit
181 vibration sensor
182 pressure sensor

What is claimed is:

1. An analysis device comprising:
a system identification unit configured to identify a model representing time evolution of a structure using a non-Gaussian random process, based on a distribution of response of the structure;
an input modeling unit configured to generate a probability model representing a distribution of an input, based on data indicating fluctuation of the input to the structure;
an input generation unit configured to generate an input signal for the structure based on the probability model; and
a response calculation unit configured to derive random response of vibration occurring in the structure in response to the input signal, based on the model and the input signal.

2. The analysis device according to claim 1, wherein the system identification unit identifies the model, based on a probability density function of displacement and velocity of the vibration which is the response.

3. The analysis device according to claim 2, wherein the system identification unit identifies the model representing time evolution of the probability density function of the displacement and the velocity of the vibration.

4. The analysis device according to claim 2, wherein the system identification unit identifies the model, based on moment of the probability density function of the displacement and the velocity of the vibration.

5. The analysis device according to claim 1, wherein the structure is a pipe.

6. The analysis device according to claim 5, wherein the input modeling unit generates the probability model representing distribution of pressure based on fluctuation of pressure of fluid flowing through the pipe collected in a predetermined time period.

7. The analysis device according to claim 6, wherein the input generation unit generates the input signal representing the fluctuation of the pressure, based on the probability model.

8. The analysis device according to claim 7, wherein the response calculation unit derives the random response of vibration occurring in the structure in response to the fluctuation of the pressure represented by the input signal.

9. A diagnostic device comprising:
the analysis device according to claim 1;
a stress calculating unit configured to calculate stress occurring in the structure, based on the response calculated by the response calculation unit of the analysis device; and
a reliability evaluation unit configured to evaluate reliability including catastrophic failure and wear failure of the structure, based on the stress.

10. The diagnostic device according to claim 9, wherein the reliability evaluation unit comprises:
a load strength reliability evaluation unit configured to evaluate load strength reliability indicating reliability with respect to catastrophic failure of the structure;
a fatigue strength reliability evaluation unit configured to evaluate fatigue strength reliability indicating reliability with respect to wear failure of the structure; and
a comprehensive reliability evaluation unit configured to evaluate reliability of the structure, based on the load strength reliability and the fatigue strength reliability.

11. The diagnostic device according to claim 10, wherein the load strength reliability evaluation unit evaluates the load strength reliability, based on the stress and relationship between the stress and strength of the structure.

12. The diagnostic device according to claim 10, wherein the comprehensive reliability evaluation unit evaluates the fatigue strength reliability, based on the stress and fatigue strength of the structure.

13. The diagnostic device according to claim 10, wherein the comprehensive reliability evaluation unit derives the reliability of the structure, based on a product of the load strength reliability and the fatigue strength reliability.

14. An analysis method comprising:
identifying a model representing time evolution of a structure using a non-Gaussian random process, based on response of the structure;
generating a probability model representing a distribution of an input, based on data indicating fluctuation of the input to the structure;
generating an input signal for the structure based on the probability model; and
deriving random response of vibration occurring in the structure in response to the input signal, based on the model and the input signal.

15. A non-transitory computer-readable recording medium storing a program for causing a computer to execute:
processing of identifying a model representing time evolution of a structure using a non-Gaussian random process, based on response of the structure;
processing of generating a probability model representing a distribution of an input, based on data indicating fluctuation of the input to the structure;
processing of generating an input signal for the structure based on the probability model; and
processing of deriving random response of vibration occurring in the structure in response to the input signal, based on the model and the input signal.
